(19) United States
(12) Patent Application Publication
(10) Pub. No.: US 2012/0012469 A1
(43) Pub. Date: Jan. 19, 2012

(54) METHOD FOR PRODUCING BORES

(76) Inventors: Juergen Hackenberg, Sachsenheim (DE); Harry Kroetz, Dornstetten (DE)

(21) Appl. No.: 13/138,166

(22) PCT Filed: Jan. 13, 2010
(86) PCT No.: PCT/EP2010/050353

§ 371 Date: Sep. 30, 2011

(30) Foreign Application Priority Data
Jan. 15, 2009 (DE) 10 2009 000 237.5

(51) Int. Cl. B23H 3/00

(52) U.S. Cl. 205/662

(57) ABSTRACT

In a method for producing bores, a tool connected as a cathode and a workpiece connected as an anode are connected to a voltage source. The workpiece and the tool are connected to one another in an electrically conductive manner via an electrolyte, and an electrical potential difference between the workpiece and the tool is formed at least at times for removing material from the workpiece. Furthermore, the workpiece and the tool are subjected to a relative movement in relation to one another for producing the bore. The potential difference between the workpiece and the tool is formed by a corresponding voltage level in such a way that a gas-vapor envelope which surrounds the tool is formed.

### BACKGROUND OF THE INVENTION

1. Field of the Invention

The present invention relates to a method for producing bores, e.g., in fuel injectors.

2. Description of Related Art

Such a method is used in particular for producing bores having relatively small diameters (so-called micro-bores) such as those used, for example, in injectors in internal combustion engines. For process-related reasons, however, material is also always removed from places on the workpiece where this is not desired. This is caused by electric fields related to the electrode geometry. Material is preferably removed from places having a relatively high electrical field strength because the current density is highest there. High field strengths occur primarily on sharp edges or corners, causing them to become eroded and rounded during processing. A higher conductivity of the working medium causes this effect to be all the more pronounced. For this reason, cylindrical bores having high precision, i.e., having as little material removal as possible on the edges of the bore in particular, are able to be produced using the known method only if an insulated electrode is used. However, to date, suitable insulation means allowing high stability with low insulation layer thicknesses are not available. For that reason, the production of such bores having small diameters is associated with relatively high costs.

### BRIEF SUMMARY OF THE INVENTION

An object of the present invention is to produce bores having a small diameter at high precision, in particular in the edge area of the bore, in a highly economical manner without using insulated electrodes.

The present invention is based on the idea of selecting the potential difference or the applied voltage between the two electrodes at such a high level that a gas-vapor envelope is produced around the tool forming the cathode via the electrolyte. This produces a field-free space between the gas-vapor envelope and the workpiece surface preventing material from being removed electrochemically, in particular in the opening area of the bore.

In an advantageous refinement of the present invention, the working voltage and thus the potential difference is varied, in particular pulsed. This also makes it possible to produce relatively small bores using a small tool without it being subjected to severe heat or increased wear.

In addition, it is possible to influence the wear of the tool in pulsed operation by appropriately prolonging the machining intervals in which no potential difference is present between the workpiece and the tool.

In pulsed operation, it is furthermore particularly advantageous to adjust the curve of the relative movement between the workpiece and the tool to the curve of the potential difference. This increases the precision of the machining process.

### BRIEF DESCRIPTION OF THE DRAWINGS

FIG. 1 shows a simplified schematic diagram of a method for producing a bore using a non-insulated electrode according to the related art.

FIG. 2 shows a simplified schematic diagram according to FIG. 1, however using the method according to the present invention.

FIG. 3 shows the voltage drop curve across a plasma column using a method according to the present invention according to FIG. 2.

### DETAILED DESCRIPTION OF THE INVENTION

Identical elements and elements having the same function are denoted using the same reference symbols.

A conventional method for producing a bore 1 in a workpiece 10 is represented in FIG. 1. A wire-shaped tool 11 connected as a cathode to a voltage source (not shown) is moved in the direction of arrow 12, material being removed in the desired manner from workpiece 10 which is connected as an anode to the voltage source. In this case, at least the entire machining area of workpiece 10 in the area of bore 1 is surrounded by an electrolyte which is in contact with both workpiece 10 and tool 11. The method thus described is known as a so-called ECM method. It is noted in particular that if tool 11 is not insulated, there is increased removal of material in the area of bore opening 13, resulting in a rounded bore edge 14. Using the known method using a non-insulated tool 11, it is thus not possible to achieve the desired cylindrical geometry of bore 1 over the entire bore depth, at least in the area of bore opening 13.

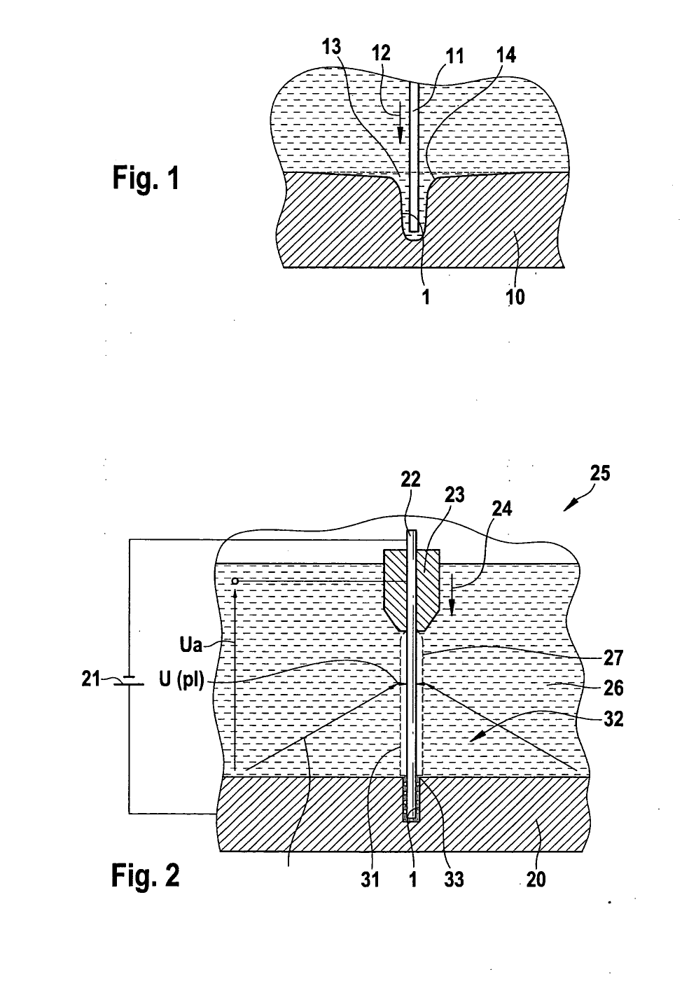

In the case of the method according to the present invention represented in FIG. 2 for producing a bore 1, a workpiece 20 is connected as an anode to a voltage source 21 in a manner analogous to the method according to FIG. 1. Wire-shaped tool 22 is guided in a tool support 23 and is subjected to a feed motion in the direction of arrow 24. In this connection, tool 22 is connected as a cathode to voltage source 21.

The entire system made up of workpiece 20 and tool 22 is located in a known manner in a production device 25 (not represented in greater detail) and is surrounded by an electrolyte 26 or an electrolyte solution. For example, electrolyte 26 has a conductivity greater than 10 mS/cm. When a working voltage is applied between the anode and cathode, denoted in the following as voltage Ua, the electrolysis causes hydrogen to be deposited on the cathode surface, i.e., on the surface of tool 22. According to the present invention, it is provided to select the potential difference between workpiece 20 and tool 22, i.e., voltage Ua at voltage source 21, at such a (high) level that the tool surface is completely surrounded by a gas-vapor envelope 27 which is at times penetrated by a plasma channel. In the case of small bore diameters, this is typically achieved at voltages Ua greater than 50 V. Similar to a thunderstorm, the plasma repeatedly penetrates gas-vapor envelope 27 at a consistently different location. If breakdown voltages occur, these are on the one hand breakdown voltages through gas-vapor envelope 27 between tool 22 and bore 1 within bore 1. Removal of material thus occurs only within bore 1 in this case. In the other breakdown voltages between electrolyte 26 and tool 22 outside of bore 1, the current first flows through the plasma channel, then through electrolyte 26 (U(electrolyte) not zero) and could result in the removal of material outside of bore 1. Since, however, the plasma limits the current flow (saturation effect), the current density on the workpiece surface is not sufficient for achieving removal of material. In the desired manner, this results in the formation of a relatively sharp-edged bore edge 33. It is noted in addition that a penetration through gas-vapor envelope 27 may also result in igniting of the hydrogen, primarily in the case of a penetration between tool 22 and workpiece 20, since both oxygen and hydrogen are in gas-vapor envelope 27 at this location.

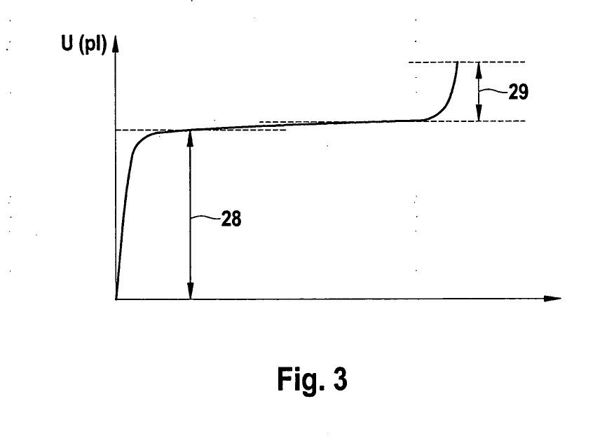

Voltage Ua is broken down into a voltage component U(electrolyte) across electrolyte 26 and a voltage component U(pl) across the plasma. As seen in FIG. 3, which represents the voltage drop across the plasma column in a gas discharge, voltage Upl is broken down into a cathode drop 28 and an anode drop 29. Since the plasma is in contact with one side of workpiece 20 to be machined, a conductive connection exists between the workpiece surface and the anode of the plasma, which is represented by dashed line 31 in FIG. 2.

The level of voltage Ua determines whether or not a plasma is formed. It has been found that the plasma ignites only very irregularly in the present example at voltages Ua of less than 70 V, so that the protection of the workpiece surface against electrochemical erosion is only partially present. For that reason, erosion occurs primarily at bore edge 33, since that is where the highest field strengths occur.

If, however, voltage Ua is increased to 105 V (at a conductivity of electrolyte 26 of 20 ms/cm), relatively sharp-edged bore edges 33 corresponding to FIG. 2 are obtained.

It is noted in addition that in the case of small tool/electrode diameters of approximately 100 μm, it is recommended to pulse voltage Ua, since otherwise the temperature on tool 22 may become so high in the presence of a direct voltage that it melts. The duration of pulse length and pulse interval (as well as voltage Ua) is in this case a parameter for influencing the intensity of the plasma. Shortening the pulse interval reduces the heating of the plasma. In long pulse intervals, the plasma is extinguished at times and an electrochemical erosion occurs on bore edge 33 (as is also the case at relatively low voltage Ua), which may be advantageously exploited. During the pulse intervals, it may be advantageous to reduce or stop the otherwise continuous feed motion of tool 22. Moreover, the relative velocity between tool 22 and workpiece 20 should advantageously be adjusted to the curve of voltage Ua to increase the bore's precision.

Using the method according to the present invention described above, it is thus possible in particular to produce high-precision bores having relatively small diameters (in particular having diameters smaller than 1 mm or a diameter to depth ratio of 1:10, so-called micro-bores), in particular in the opening area of the bores, without an insulated cathode (tool 22) being necessary for this purpose. However, in the case of a throttle bore, it is also possible to use the described method to produce the bore first, and subsequently widen the throttle bore electrochemically to the desired dimension in the same fixture of same production device 25 using same electrolyte 26, or round bore edge 33 of a micro-bore in a targeted manner (already in the boring process or also afterwards using a relatively low voltage Ua at which the plasma does not immediately ignite).

1-9. (canceled)

10. A method for producing a bore in a workpiece, comprising:
connecting a tool and the workpiece to a voltage source, wherein the tool is connected as a cathode and the workpiece is connected as an anode, and wherein the workpiece and the tool are connected in an electrically conductive manner via an electrolyte;
providing by the voltage source an electrical potential difference between the workpiece and the tool to remove material from the workpiece, wherein the potential difference between the workpiece and the tool causes a gas-vapor envelope to be formed which at least partially surrounds the tool, and wherein plasma penetrations are formed in the gas-vapor envelope; and
providing a relative movement between the workpiece and the tool for producing the bore in the workpiece.

11. The method as recited in claim 10, wherein the potential difference provided by the voltage source is pulsating such that phases having maximum potential difference alternate with phases having reduced potential difference compared to the full potential difference.

12. The method as recited in claim 11, wherein the potential difference alternates between the maximum potential difference and zero.

13. The method as recited in claim 11, wherein the duration of the maximum potential difference is different from the duration of the reduced potential difference.

14. The method as recited in claim 13, wherein the bore has a maximum diameter of 1000 μm.

15. The method as recited in claim 13, wherein the potential difference is greater than 50 volts at a conductivity of the electrolyte at least equal to 5 mS/cm.

16. The method as recited in claim 15, wherein the relative movement between the tool and the workpiece is discontinuous and is adjusted to the curve of the potential difference.

17. The method as recited in claim 15, wherein the tool is wire-shaped.

18. The method as recited in claim 15, wherein the bore is produced in the workpiece in a first work step, and wherein the bore is machined further using the tool in an additional work step.
